(19) United States
(12) Patent Application Publication
(10) Pub. No.: US 2002/0155810 A1
(43) Pub. Date: Oct. 24, 2002

(54) Device for controlling automotive audio systems and the like

(76) Inventor: Curtis Robert Tate, Northfield, IL (US)

Correspondence Address: CURTIS R. TATE, 586 EARL DRIVE, NORTHFIELD, IL, 60093-1106, US

(21) Appl. No.: 10/057,389

(22) Filed: Jan. 25, 2002

Related U.S. Application Data
(60) Provisional application No. 60/178,131, filed on Jan. 26, 2000.

(51) Int. Cl. H04B 5/00

(52) U.S. Cl. 455/41; 455/550; 455/556; 455/557

(57) ABSTRACT

A device for use with cellular telephones to control the output of automotive audio systems and the like is described. It is based on a system comprising a digitally coded transmitter, a low frequency transmitter, a RF antenna sensor, and a receiver- switching system. When the cellular phone is in use, operation of the automotive audio system will be interrupted. Upon termination of usage of the cellular telephone, operations of the automotive audio system will resume.

This is an application based on Provisional Application No. 60,178,131, filing date Jan. 26, 2000. An image of the official receipt from the United States Patent Office thereof is at attached hereto.

### INTRODUCTION

A typical user of a cellular telephone inside a vehicle often finds himself reaching to turn down the car radio whenever a phone call is placed or received. A loudly playing radio interferes with both sides of the telephone conversation; the caller in the car finds it difficult to hear the called party and it is similarly distracting to receive a phone call only to hear a radio playing. Of course, the radio which was just turned down must then be turned back up after the end of the phone conversation. Adjusting the car radio must of course be done in addition to using the telephone and safely driving the car.

### FIELD OF THE INVENTION

This invention relates to a system to be used with a cellular telephone for automatically controlling electronic devices such as automobile audio systems. A transmitter is externally and removably attached to, or placed in the vicinity of, a cellular telephone, and the fuse block of the electronic device to be controlled is replaced by a receiver module. When a cellular telephone is in use, the electronic device such as an automobile audio system will be disabled. When use of the cellular telephone is terminated, operation of the electronic device will automatically resume.

### BACKGROUND OF THE INVENTION

### Description of Prior Art.

Because of the popularity of cellular phones in automobiles and the well recognized need for hands-free operations or otherwise controlling their usage, several devices have been described in the prior art. In general, however, such devices are either inconvenient to use or to install, or have poor audio-output characteristics.

Typically, earlier inventions in this genre required modification of the circuitry of a cellular telephone by opening up, and rewiring, of the phone itself. These are exemplified in patents by Wheller in U.S. Pat. No. 5,025,467, and earlier patents such as those described by Bush et al. In U.S. Pat. No. 4,214,131 and by Watterbarger in U.S. Pat. No. 4,076,968. More recently, Hayes et al. described in U.S. Pat. No. 5,867,794 a system which permits the use of the FM radio of a car for the output of a cell phone. In U.S. Pat. No. 5,802,467, Salazar and Molero-Castro et al. disclosed a systems command, control and sensing system for communication of sound, voice, and data. Similarly, in U.S. Pat. No. 5,671,267, August et al. described an interactive system for communications between a cordless telephone and a remotely operating device. In U.S. Pat. No. 5,537,673, Nagashima described the modification of a car stereo by the addition of a removable panel having a plurality of buttons, including one for the operation of a cellular telephone system. Levi described in U.S. Pat. No. 5,678,200 a device for muting the audio output of an electronic device, but required a fairly complex circuitry and consequently would be more expensive to manufacture and also would require greater quality control of the various components to insure reliability. Similarly, Wavroch and Machado described a call alert system in U.S. Pat. No. 5,404,391 which also provided a mute function, but involves again a relatively complex circuitry.

It is the objective of the present invention to create a device which would be simple to manufacture, easy to install, and easy to use. In the present invention, I have successfully constructed a two-component system with a simplified circuitry and therefore easy to manufacture. One component, the sensor-transmitter, is conveniently and removably mounted outside the cellular phone to be used. The second component, the receiver-muter, is simply used in place of the fuse block of an audio equipment. Minimal skills is therefore needed, offering thereby superior convenience to an ordinary consumer-user.

### BRIEF DESCRIPTION OF THE INVENTION

The purpose of this invention is to automatically turn off the automotive audio equipment (e.g., a car radio, a cassette or CD player, an AM or FM receiver, or the like) whenever a cellular telephone is being used within a motor vehicle such as a car, a van, a truck, a bus. Additionally, the present invention could also be adopted for use in stationary settings such as a radio in an office or at home.

The present invention has two main modular components. The first component consists of a detector of phone signals, a timing circuit, and a circuit for transmitting its own coded signal. The second component consists of a receiver for said coded signal and a circuit for disabling (interrupting) the power supply to the car radio or other audio equipment. When the cellular telephone is in use, the power supply will be interrupted. When usage of the cellular phone is terminated, said power supply will be restored. Since no other setting is affected, the audio equipment will resume its operation without any memory loss in volume control, station selection, etc.

### DETAIL DESCRIPTIONS

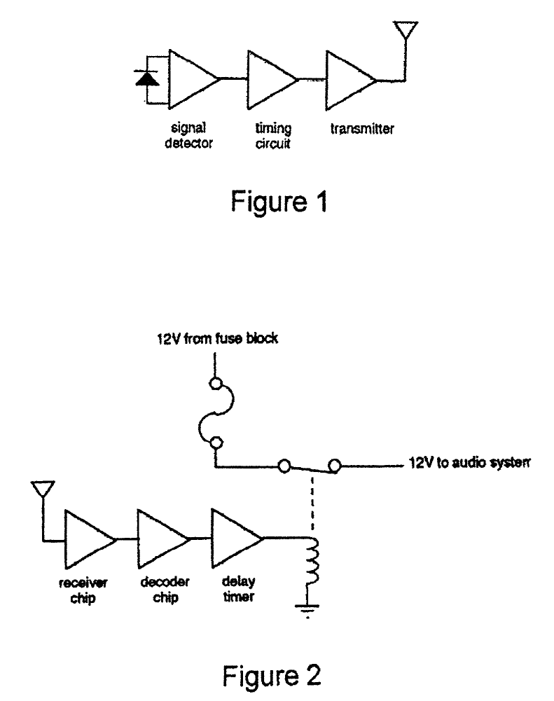

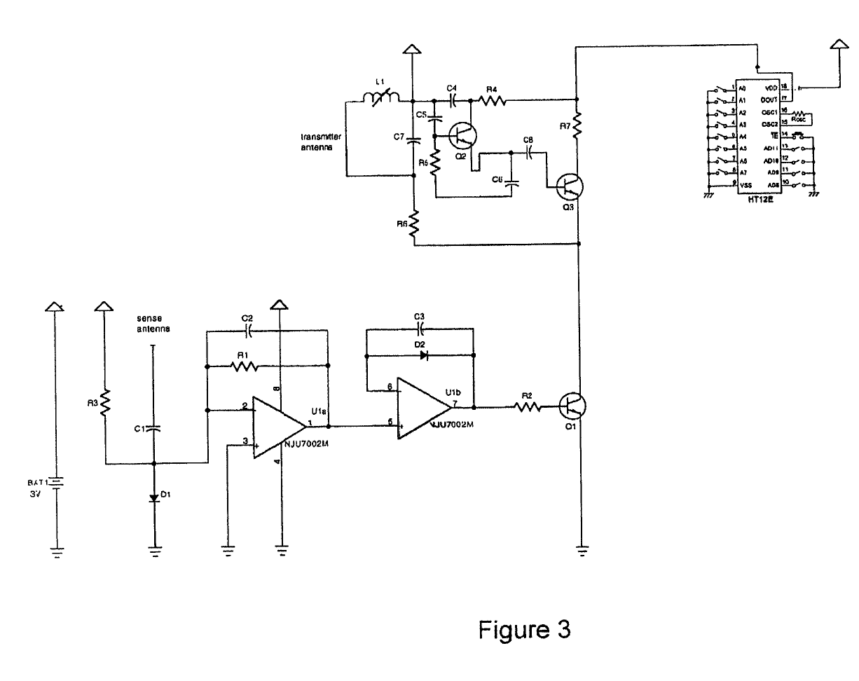

The general concepts of the present invention are shown in FIGS. 1 and 2, representing respectively the detector/transmitter module (transmitter module) and the receiver module. In our initial development, successful prototypes have also been made for the transmitter module using generally a diode based radio frequency detector together with a timing circuit and a small radio frequency detector; and successful prototypes have been made for the receiver module using a single chip UHF radio receiver, a decoder chip, a delay timer, a power relay, and a fuse.

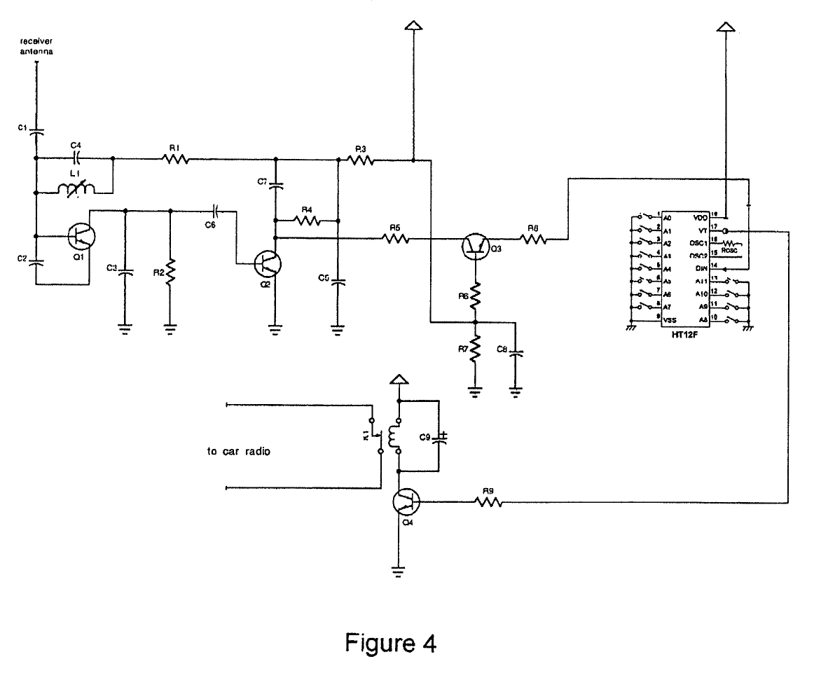

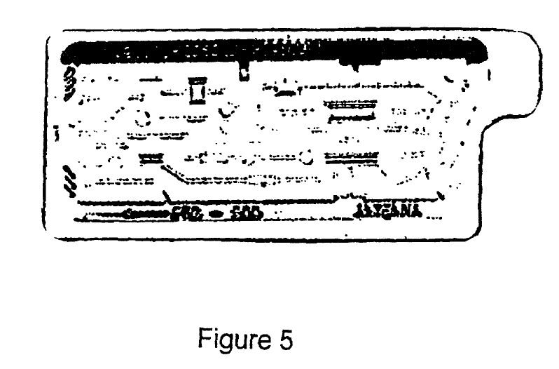

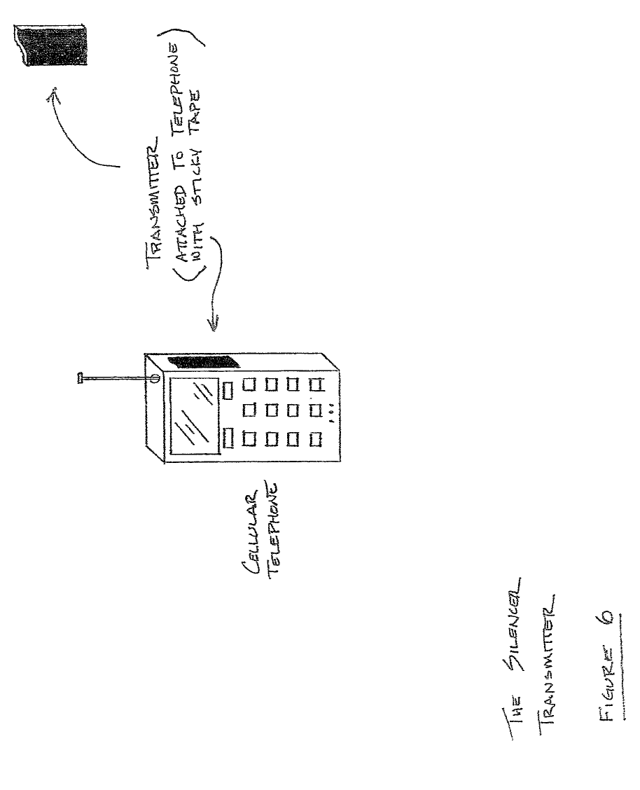

The detailed circuitry of the presently best mode of my invention is depicted in FIGS. 3 and 4. FIG. 3 is the detailed circuitry of the transmitter module and the specifications of the components used therein are listed in Table 1. FIG. 4 is the detailed circuitry of the receiver module and the specifications of the components used therein are listed in Table 2. FIG. 5 is a physical illustrations of a detached transmitter module. FIG. 6 is an illustration of the receiver module.

Two steps are needed to install the components of the present system. One step is to attach (e.g. using adhesive tape backing) the transmitter to the side of a cell phone as illustrated in FIG. 6. (It may also be mounted, however, at other sites close to the cellular phone, such a the antenna of the latter.) The other step is to remove the fuse panel, exposing the fuse block, accessing the audio equipment fuse, replace it with the receiver module, putting the fuse into the receiver module, and connecting the receiver to any metal screw in the car. (The receiver module may also be mounted at another location near the main electrical fuse block.) Since these two steps are independent of each other, they can be made in either sequence (transmitter module first, or receiver module first).

The detector is a simple diode radio frequency detector, an amplifier and threshold detector and a low power radio frequency transmitter. When a strong radio frequency signal is detected from a cellular telephone in close proximity, the detector send out its own low power radio digital frequency signal. This signal contains a basic code to minimize interference with other radio frequency systems. When the cellular phone is in use (ringing from an incoming call, placing an outgoing call, or during conversation when the phone is on), the transmitter module detects the radio frequency energy sent by the cellular telephone during such times. When the radio frequency energy from the cellular telephone is detected, the device sends out its own low power radio frequency signal to be received by the receiver module.

The receiver is a radio frequency receiver tuned to accept the coded signal from the detector. When the cellular phone system is in use, the receiver receives the signal from the detector-transmitter, and activates a relay to interrupt the power supply to the audio equipment system. This relay keeps the power interrupted during the cellular phone usage. When usage of the cellular phone ends, the radio signal from the transmitter ceases, and the receiver then restores power, turning back on the audio system.

In general, the detector can be powered by a small lithium battery whereas the receiver can be powered by the same electrical system supply power to the audio equipment. In as much as detector-transmitters with the same radio code are used, any number of cellular telephones can operate within one vehicle and any (or all) of them will be able to turn off the audio system.

It should be understood that the foregoing description is for illustrative purpose only, and is not intended to limit the scope of the invention. Rather, there are numerous equivalent to the preferred embodiments which would be obvious to those skilled in the art, and such are intended to be covered by the appended claims.

TABLE 1
Transmitter

| Ref | VALUE | DESCRIPTION | MANUF | MANUF # |
|---|---|---|---|---|
| BAT1 | 3 V | lithium cell | Panasonic | BR1225 |
| C1 | 100 pf | chip X7R | type 0402 | |
| C2 | 1000 pf | chip X7R | type 0402 | |
| C3 | 10,000 pf | chip Y5V | type 0402 | |
| C4 | 220 pf | chip X7R | type 0402 | |
| C5 | 100 pf | chip X7R | type 0402 | |
| C6 | 330 pf | chip X7R | type 0402 | |
| C7 | 100 pf | chip NPO | type 0402 | |
| C8 | 330 pf | chip X7R | type 0402 | |
| D1 | 1N914 | detector diode | any | |
| D2 | 1N914 | detector diode | any | |
| L1 | | tuning coil | TOKO | TK-2802 |
| Q1 | MA152ACT | switching | Panasonic | MA152ACT |
| | | transistor | | |
| Q2 | 2SC5019CT | rf transistor | Panasonic | 2SC5019CT |
| Q3 | 2SC5019CT | rf transistor | Panasonic | 2SC5019CT |
| R1 | 470 K | chip resistor | type 0402 | |
| R2 | 10 K | chip resistor | type 0402 | |
| R3 | 1 M | chip resistor | type 0402 | |
| R4 | 47 K | chip resistor | type 0402 | |
| R5 | 56 K | chip resistor | type 0402 | |
| R6 | 120 K | chip resistor | type 0402 | |
| Rosc | 390 K | chip resistor | type 0402 | |
| R7 | 33 K | chip resistor | type 0402 | |
| U1 | NJU7002M | dual amplifier | JRC | NJU7002M |
| U2 | HT12E | encoder | Holtek | HT12E |

TABLE 2
Receiver

| Ref | VALUE | DESCRIPTION | MANUF | MANUF # |
|---|---|---|---|---|
| C1 | 100 pf | chip X7R | type 0402 | |
| C2 | 100 pf | chip X7R | type 0402 | |
| C3 | 470 pf | chip X7R | type 0402 | |
| C4 | 100 pf | chip NPO | type 0402 | |
| C5 | 1000 pf | chip X7R | type 0402 | |
| C6 | 220 pf | chip X7R | type 0402 | |
| C7 | 330 pf | chip X7R | type 0402 | |
| C8 | 1000 pf | chip X7R | type 0402 | |
| C9 | 47 μf | electrolytic, 16 V | any | |
| K1 | relay | 12 V type 1B contacts | Aromat | DF2E- |
| | | | | DC12V |
| L1 | 1N914 | tuning coil | TOKO | TK-2802 |
| Q1 | 2SC5019CT | rf transistor | Panasonic | 2SC5019CT |
| Q2 | 2SC5019CT | rf transistor | Panasonic | 2SC5019CT |
| Q3 | 2SC5019CT | rf transistor | Panasonic | 2SC5019CT |
| Q4 | 2N4401 | switching transistor | any | |
| | | TO-92 | | |
| R1 | 56 K | chip resistor | type 0402 | |
| R2 | 100 K | chip resistor | type 0402 | |
| R3 | 22 K | chip resistor | type 0402 | |
| R4 | 100 K | chip resistor | type 0402 | |
| R5 | 33 K | chip resistor | type 0402 | |
| R6 | 33 K | chip resistor | type 0402 | |
| R7 | 56 K | chip resistor | type 0402 | |
| R8 | 3.9 K | chip resistor | type 0402 | |
| R9 | 10 K | chip resistor | type 0402 | |
| U1 | HT12F | decoder | Holtek | HT12F |

What is claimed is:

1. A wireless technology device to be used on a cellular telephone for controlling the output of an audio system, said device comprising:
a detecting and transmitting means;
a receiving means;
a power means; and
an attachment means.

2. The detecting and transmitting means in accordance with claim 1 to detect the signals from the cellular telephone in claim 1, said means consisting of a detecting and transmitting module further comprising:
a diode radio-frequency detector;
a low power radio-frequency detector;
an amplifier;
a threshold detector; and
a low power radio-frequency transmitter.

3. The receiving means in accordance with claim 1, said means tuned to accept the signals from the transmitting means and consisting of a receiver module having physical dimensions compatible with the fuse block of the audio system to be controlled. Said receiver module further comprising:
a UHF radio receiver;
a decoder chip;
a delay timer;
a power relay; and
a fuse.

4. The power means in accordance with claim 1 further comprising a lithium battery.

5. The attaching means for attaching the transmitter to the cellular telephone in accordance with claim 1, said attaching means being made from the following classes of fastening materials: velcro, adhesive, or mechanical.
